(19) United States
(12) Patent Application Publication
(10) Pub. No.: US 2009/0083838 A1
(43) Pub. Date: Mar. 26, 2009

(54) Method and System For Assuring Security of a Transaction in a Telecommunicaiton Network

(75) Inventor: Louis Neau, Chateaugiron (FR)

Correspondence Address: Nixon Peabody LLP, 200 Page Mill Road, Palo Alto, CA, 94306, US

(73) Assignee: VIACCESS, Paris La Defense Cedex (FR)

(21) Appl. No.: 11/922,175

(22) PCT Filed: Jun. 12, 2006
(86) PCT No.: PCT/FR2006/050547

§ 371 Date: Dec. 12, 2007

(30) Foreign Application Priority Data
Jun. 14, 2006 (FR) 0551602

(51) Int. Cl. H04L 9/32; G06F 21/00; G06Q 30/00

(52) U.S. Cl. 726/5; 705/35

(57) ABSTRACT

The invention relates to a method for a beneficiary to acquire a right to use a digital content in a contents distribution system comprising a commercial server (2), a rights server (4) and an operations platform (5) for said content, said platform (5) comprising at least one module (6) to purchase a usage right and at least one module (8) for using the purchased right, said purchase module (6) being capable of communicating with said commercial server (2) through a first application protocol specific to the commercial server (2), and said module (8) for using the purchased right being capable of communicating with said rights server (4) through a second application protocol specific to the rights server (4).

This method comprises a third protocol consisting of:

defining an identifier I1 of the beneficiary with the commercial server (2) and an identifier I2 of said beneficiary with the rights server (4),

setting up a correspondence between the identifier I1 and the identifier I2 to enable an exchange of data related to the beneficiary identified by one or the other of the identifiers I1 and I2, between said servers.

### DOMAIN OF THE INVENTION

The invention is related to the field of distribution of digital contents and more specifically relates to a method for a beneficiary to acquire a right to use a digital content in a contents distribution system comprising a commercial server, a rights server and an operations platform for said content, said platform comprising at least one module to purchase a usage right and at least one module for using the purchased right, said purchase module being capable of communicating with said commercial server through a first application protocol specific to the commercial server, and said module for using the purchased right being capable of communicating with said rights server through a second application protocol specific to the rights server.

The invention concerns also a system that a beneficiary uses for acquisition of a right to use a digital content comprising a commercial server, a rights server and an operations platform for said content, said platform comprising a rights purchase module capable of communicating with said commercial server through a first application protocol specific to the commercial server and a module for using the purchased right capable of communicating with said rights server through a second application protocol specific to the rights server.

The invention also relates to a commercial transaction management server in a contents distribution system also comprising a digital content usage rights server and an operations platform for said content, said platform comprising a purchase module of a right for a beneficiary capable of communicating with said commercial server through a first application protocol specific to the commercial server and a module for using the purchased right capable of communicating with said rights server through a second application protocol specific to the rights server.

The invention also relates to a digital content usage rights server in a contents distribution system also comprising a commercial server and an operations platform of said content, said operations platform comprising a purchase module that a beneficiary uses to purchase a right, capable of communicating with said commercial server through a first application protocol specific to the commercial server and a module for using the purchased right capable of communicating with said rights server through a second application protocol specific to the rights server.

The invention is applicable to the context of connected networks (Internet, mobile telephony networks, etc.) or broadcast networks (satellite broadcast television networks, IP networks), in which the exchanged contents are protected by a Conditional Access System (CAS) or by a Digital Rights Management (DRM) system.

### STATE OF PRIOR ART

In contents distribution systems of prior art, access to contents is obtained through a procedure comprising two distinct steps, a first step to purchase the right and a second step to acquire the purchased right. These two steps are usually executed on different servers with distinct communication protocols.

FIG. 1 diagrammatically illustrates a content distribution system comprising a commercial server 2, a rights server 4 and an operations platform 5 of a content comprising a purchase module 6 of a usage right and a module 8 for use of the purchased right. The purchase module 6 and the usage module 8 of the right use communication networks 10 and 11 that may be separate or the same, to communicate with the commercial server 2 and with the rights server 4 respectively. Communications between the purchase module 6 and the commercial server 2 are governed by a first application protocol 12 that can comprise a first security protocol 14 specific to the commercial server 2, while communications between the usage module 8 and the right server 4 are governed by a second application protocol 16 that can comprise a second security protocol 18 specific to the right server 4. Acquisition of the usage right in the system described above has a first disadvantage resulting from the fact that the application protocols and the security protocols on the commercial server 2 and the rights server 4 respectively do not a priori use the same identification and security procedures. This makes information exchanges between the servers involved in the transaction more complicated or even impossible.

Furthermore, when the distributed contents are protected by an access right, the servers involved in the distribution chain may have distinct security protocols that impose complex and expensive processings to adapt them to each other to assure end to end security of the transaction.

Furthermore, the managers of the two servers do not always wish to integrate or to modify the protocols.

The purpose of the invention is to enable exchange of information related to the beneficiary of the right between these distinct servers with different application and security protocols, without modifying the existing protocols.

### PRESENTATION OF THE INVENTION

The invention is based on an acquisition process for a beneficiary of a digital content usage right in a content distribution system comprising a commercial server, a rights server and a digital content operations platform, said platform comprising at least one module for purchasing a usage right and at least one module for using the purchased right, said purchase module being capable of communicating with said commercial server through a first application protocol specific to the commercial server, and said module for using the purchased right being capable of communicating with said rights server through a second application protocol specific to the rights server.

The method according to the invention comprises a third protocol consisting of:
defining an identifier I1 of the beneficiary with the commercial server and an identifier I2 of said beneficiary with the rights server,
setting up a correspondence between the identifier I1 and the identifier I2 to enable an exchange of data related to the beneficiary, between said servers, when the beneficiary is identified by one or the other of the identifiers I1 and I2.

Preferably, said data related to the beneficiary are exchanged by said servers through said operations platform.

According to one essential characteristic of the invention, data related to the beneficiary received from the operations platform of one of the servers are transferred without modification to the other server such that the operations platform only performs a routing function of said data between the commercial server and the rights server.

The correspondence between identifier I1 and identifier I2 is preferably saved in a database accessible by the commercial server and/or the rights server.

In one preferred embodiment of the method according to the invention, acquisition of the usage right comprises a preliminary step consisting of sending an electronic ticket from the commercial server to the purchase module to certify the effective purchase of the right and particularly comprising an identifier of the content and an identifier of the beneficiary.

When the commercial server receives a right purchase request, it inserts the identifier of the beneficiary in the electronic ticket.

In a first embodiment, the beneficiary identifier inserted in the ticket is identifier I2 corresponding to identifier I1 determined by the commercial server from the database.

In a second embodiment, the beneficiary identifier inserted in the ticket is identifier I1 received by the commercial server in the purchase request.

The electronic ticket preferably comprises addressing information related to the commercial server and/or the rights server to enable the platform to perform the routing function for data related to the beneficiary.

The invention also relates to an acquisition system that a beneficiary of a usage right uses to acquire a digital content comprising a commercial server, a rights server and an operations platform of said content, said platform comprising a purchase module of a right capable of communicating with said commercial server through a first application protocol specific to the commercial server and a purchased right usage module capable of communicating with said rights server through a second application protocol specific to the rights server.

The system according to the invention comprises:
means of defining an identifier I1 of the beneficiary with the commercial server and an identifier I2 of said beneficiary with the rights server,
means of setting up a correspondence between the identifier I1 and the identifier I2 to enable an exchange of data related to the beneficiary when the beneficiary is identified by one or the other of the identifiers I1 and I2, between said servers.

This system also comprises a database accessible by the commercial server and/or the rights server and comprising the correspondence between the identifier I1 and the identifier I2.

The invention also relates to a commercial server for management of a transaction in a contents distribution system also comprising a digital content usage rights server and an operations platform of said content, said platform comprising a purchase module of a right for a beneficiary capable of communicating with said commercial server through a first application protocol specific to the commercial server, and a module for using the purchased right capable of communicating with said rights server through a second application protocol specific to the rights server.

The commercial server according to the invention comprises a communication module supporting a third application protocol enabling said commercial server and the rights server to exchange data related to the beneficiary, independently of said first and second application protocols.

This third application protocol uses means of setting up a correspondence between a beneficiary identifier with the commercial server, and an identifier of said beneficiary with the rights server, and a database in which said correspondence is recorded.

The invention also relates to a digital content usage rights server in a contents distribution system also comprising a commercial server and an operations platform of said content, said operations platform comprising a right purchase module for a beneficiary capable of communicating with said commercial server through a first application protocol specific to the commercial server and a module for using the purchased right capable of communicating with said rights server through a second application protocol specific to the rights server.

The rights server according to the invention comprises a communication module supporting a third application protocol enabling said commercial server and said rights server to exchange data related to the beneficiary independently of said first and second application protocols.

This third application protocol uses means of setting up a correspondence between an identifier of the beneficiary with the commercial server and an identifier of said beneficiary with the rights server, and a database in which said correspondence is recorded.

### BRIEF DESCRIPTION OF THE FIGURES

Other special features and advantages of the invention will become clearer after reading the description given below as a non-limitative example, with reference to the appended figures, wherein:

FIG. 1, described above, diagrammatically represents a contents distribution system according to prior art,

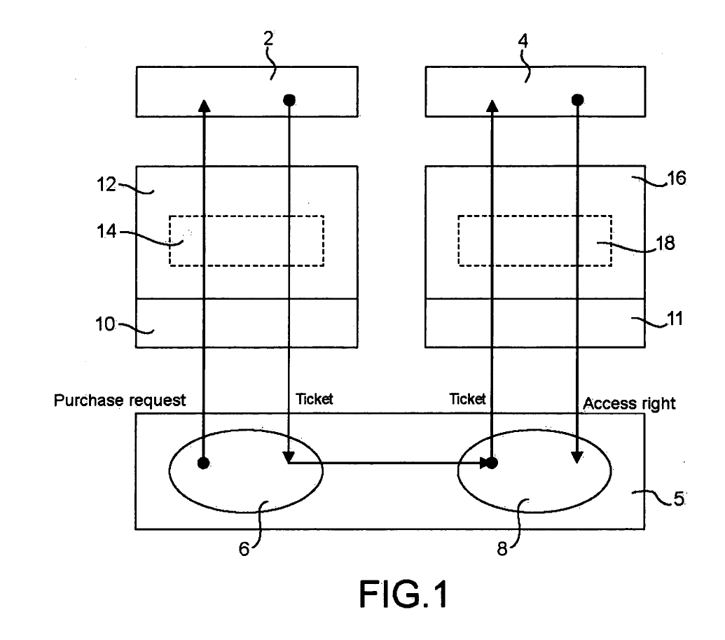

FIG. 2 diagrammatically represents a contents distribution system according to the invention,

FIG. 3 is a flow chart illustrating a particular embodiment of the method according to the invention.

### DETAILED PRESENTATION OF PARTICULAR EMBODIMENTS

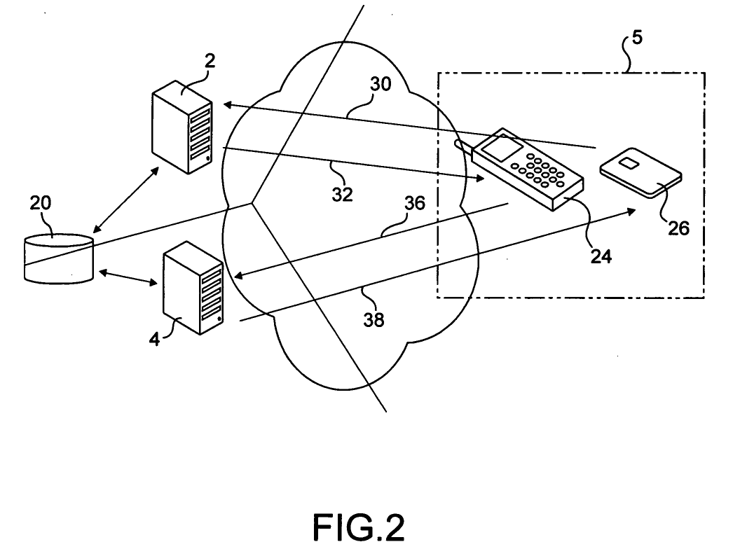

FIG. 2 diagrammatically illustrates a digital content distribution system comprising a commercial server 2, a rights server 4, a database 20 and an operations platform 5. The commercial server 2 and the rights server 4 can each be connected to the database 20 and can share information in this database 20.

The rights server 4 may be a Digital Right Management (DRM) server, or a Conditional Access System (CAS). The digital content may represent audio data, video data or multimedia data.

The method according to the invention can be used in a context in which the operations platform 5 comprises one or several rights purchasing terminals and one or several purchased rights beneficiary terminals. In this case, the usage right is purchased through a purchasing terminal, for the benefit of a user terminal. The purchase module 2 is then integrated into at least one purchasing terminal and the usage module is integrated into at least one terminal of the beneficiary of the purchased right.

For reasons of clarity, the following description relates to an example embodiment illustrated in FIG. 2, in which the operations platform 5 comprises a communication terminal 24 that is both purchaser and beneficiary of the usage right of a digital content.

In this example embodiment, the communication terminal 24 is a UMTS mobile telephone provided with a SIM (Subscriber Identity Module) card 26 and comprising a purchase module capable of communicating with the commercial server 2 through a first application protocol specific to the commercial server 2, and a module for use of the purchased right capable of communicating with the rights server 4 through a second application protocol specific to the rights server 4. The purchase module is software used to purchase the right and the usage module is software used to obtain the purchased right.

Note that the terminal 24 may be a personal digital assistant (PDA) or a laptop computer, without departing from the scope of the invention.

With reference to FIG. 2, the terminal 24 is identified to the commercial server 2 by a first identifier I1 and to the rights server 4 by a second identifier I2. The identifiers I1 and I2 are previously memorized in the SIM card 26 of terminal 24 and in the database 20. This database comprises a first directory containing a list of correspondences between the services supplied to the terminal 24 and the rights associated with these services, and a second directory containing a list of correspondences between the identifier I1 and the identifier I2.

During operation, the terminal 24 transmits a purchase request to the commercial server 2 (arrow 30), including in particular the identifier of the digital content and the identifier I1 of terminal 24. When this request is received, the commercial server 2 generates an electronic ticket comprising the content identifier, inserts the identifier of the beneficiary in this electronic ticket and sends this ticket (arrow 32) to the terminal 24. In a first embodiment, the identifier of the beneficiary inserted into the ticket is identifier I2 determined by the commercial server starting from the base 20 in correspondence with the identifier I1. In another embodiment, the identifier of the beneficiary inserted in the ticket is identifier I1 received by the commercial server in the purchase request.

To enable the beneficiary to access the content, the ticket is sent from the terminal 24 to the rights server 4 (arrow 36), as it was received from the commercial server 2 without any modification. Thus, the terminal 24 acts exclusively as a router during this transaction.

When the rights server receives the ticket, the rights server determines the beneficiary of the right corresponding to the ticket. In the first embodiment in which the ticket contains the beneficiary's identifier I2, the beneficiary is directly identified by this identifier. In another embodiment in which the ticket contains the beneficiary's identifier I1, the rights server 4 uses the database 20 to determine the identifier I2 of the beneficiary in advance by correspondence with the identifier I1 received in the electronic ticket. When the beneficiary has been identified, the rights server generates the right related to the content identified in the ticket and sends the generated right to the terminal 24 (arrow 38).

Advantageously, the commercial server 2 associates a cryptographic redundancy with the electronic ticket so that the rights server 4 will be able to check the authenticity and/or integrity of the content of said ticket. Said cryptographic redundancy may for example be an electronic signature generated using a private key of the commercial server 2. The authenticity and/or integrity of said ticket is checked using a public key of the commercial server 2 provided beforehand to the rights server 4.

In this case, when the ticket is received by the rights server 4, the right server checks the cryptographic redundancy to check the authenticity and integrity of said ticket. If the cryptographic redundancy of the received ticket is correct, the rights server identifies the beneficiary, and then generates and sends the right corresponding to the ticket as described above.

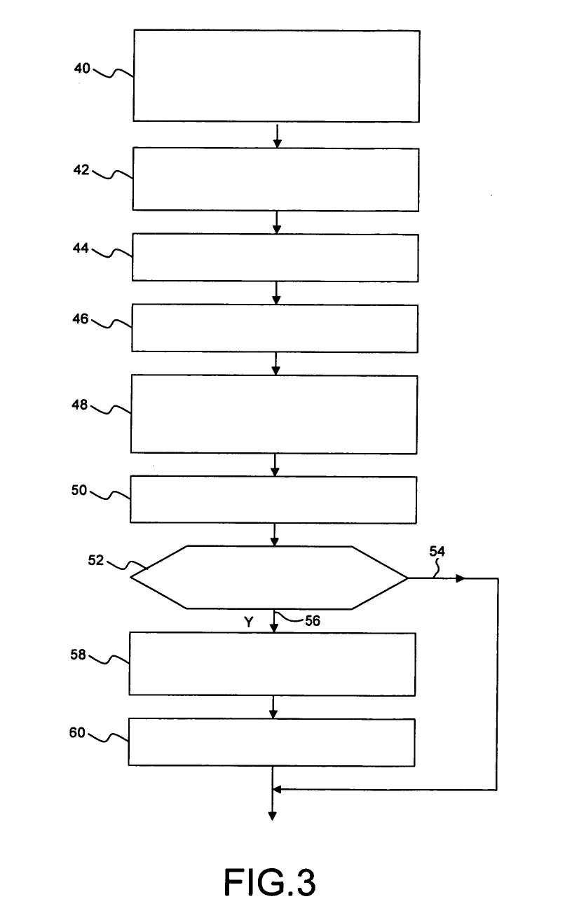

The flow chart in FIG. 3 illustrates a particular usage context of the method according to the invention in which the purchaser of the usage right is not the beneficiary of the purchased right.

In this context, a right is purchased through a terminal of the purchaser and the purchased right is obtained in a terminal of the beneficiary of the right.

The purchaser transmits the purchase request to the commercial server (step 40), in particular containing the identifier of the digital content and the identifier of the beneficiary of this content. When this request is received, the commercial server 2 generates an electronic ticket (step 42) un ticket comprising the identifier of the content and the identifier of the beneficiary. The ticket may also contain the description of the server(s) to which the beneficiary's terminal should connect to obtain the content and the associated rights. Optionally, in step 44, the commercial server 2 secures the content of the ticket built up in the previous step by associating an electronic signature of the commercial server 2 with said ticket, so as to enable the rights server 4 to check the authenticity and/or integrity of the content of this ticket. Said electronic signature is generated using a private key of the commercial server 2 and the authenticity and/or integrity of said ticket is checked using a public key of the commercial server 2 provided beforehand to the rights server 4.

With this procedure, the integrity of the ticket is guaranteed and the commercial server 2 is authenticated as the ticket issuer. In step 46, the commercial server 2 sends the secured ticket to the beneficiary's terminal. Note that steps 40 to 46 use the transport, application, dialogue and security protocols specific to the commercial server 2.

To enable the beneficiary to access the content, the ticket is sent to the rights server 4 (step 48) as the commercial server 2 received it.

In step 50, the rights server 4 verifies the signature contained in the ticket and checks the authenticity and integrity of said ticket, in step 52.

If the ticket is not authentic or is not complete (arrow 54), the rights server 4 refuses to deliver the right to the beneficiary.

If the ticket is authentic and complete (arrow 56), the rights server 4 issues the right to the beneficiary.

In the particular embodiment described above, the usage right is supplied to the beneficiary only if the ticket integrity and authenticity is checked. If the ticket does not include cryptographic redundancy, steps 50 and 52 and the arrow 54 are ignored.

The rights server 4 generates this right (step 58) as a function of the received ticket taking account particularly of:
the correspondence between the identifier of the beneficiary with the commercial server 2 and the identifier of this beneficiary with the rights server 4.
the correspondence between the identifier of the requested content and the usage rights corresponding to marketing of this content.

The rights server sends the generated right to the beneficiary in step 60.

Note that steps 48 to 60 use transport, application, dialogue and security protocols specific to the rights server 4.

The embodiment described above enables a secure exchange of the electronic ticket from end to end independently of the application and security protocols of the commercial server 2 and the application and security protocols of the rights server 4.

1. Method for a beneficiary to acquire a right to use a digital content in a contents distribution system comprising a commercial server (2), a rights server (4) and an operations platform (5) for said content, said platform (5) comprising at least one module (6) for purchasing a usage right and at least one module (8) for using the purchased right, said purchase module (6) being capable of communicating with said commercial server (2) through a first application protocol specific to the commercial server (2), and said module (8) for using the purchased right being capable of communicating with said rights server (4) through a second application protocol specific to the rights server (4),
method characterized in that it comprises the following steps:
defining an identifier I1 of the beneficiary with the commercial server and an identifier I2 of said beneficiary with the rights server (4),
setting up a correspondence between the identifier I1 and the identifier I2 of the beneficiary
configuring at least one of said commercial server and said rights server to convert identifier I1 into identifier I2, and during a transaction,
sending a purchase request to the commercial server (2),
generating an electronic ticket comprising one of said identifiers I1 or I2 of the beneficiary and the identifier of the content, using said commercial server (2),
sending said ticket of the commercial server (2) to the rights server (4) through the operations platform (5),
generating a purchased right as a function of the content of the received ticket, using the rights server (4),
sending the generated right to the beneficiary.

2. Method according to claim 1 in which the commercial server (2) converts the identifier I1 into indentifier I2 on reception of a request to purchase a right comprising the beneficiary's identifier I1.

3. Method according to claim 1, in which the rights server (2) converts the identifier I1 into indentifier I2 on reception of an electronic ticket comprising only the beneficiary's identifier I1.

4. Method according to claim 1 in which the correspondence between said beneficiary's identifiers I1 and I2 is recorded in a database (20) accessible by the commercial server (2) and/or the rights server (4).

5. Method according to claim 1, in which data related to the beneficiary are exchanged by said commercial server (2) and said rights server (4) through said operations platform (5), and in that said data are transferred without any modification at said platform (5).

6. Method according to claim 4 and 5, in which the rights server (4) determines the beneficiary identifier I2 by correspondence with the identifier I1 received in the electronic ticket, using the database (20), on reception of the electronic ticket comprising only the identifier I1.

7. Method according to claim 1 in which acquisition of the right by the beneficiary comprises a preliminary step consisting of sending said electronic ticket from the commercial server (2) to the purchase module (6) to certify the effective purchase of the right, and in that the commercial server (2) inserts the second identifier I2 corresponding to the first identifier I1 of said request into the electronic ticket, on reception of a right purchase request comprising the beneficiary identifier I1.

8. Method according to claim 7 comprising a step in which the commercial server (2) associates a cryptographic redundancy with the electronic ticket so that the rights server (4) is able to check the authenticity and/or integrity of the content of said ticket.

9. Method according to claim 8, in which said cryptographic redundancy is an electronic signature generated using a private key of the commercial server (2) and in that the authenticity and/or integrity of said ticket is checked using a public key of the commercial server (2) provided beforehand to the rights server (4).

10. Method according to claim 9, in which the rights server (4) generates and sends said right if the cryptographic redundancy of the received ticket is correct.

11. System that a beneficiary uses for acquisition of a right to use a digital content comprising a commercial server (2), a rights server (4) and an operations platform (5) for said content, said platform (5) comprising a rights purchase module (6) capable of communicating with said commercial server (2) through a first application protocol specific to the commercial server (2) and a module (8) for using the purchased right, capable of communicating with said rights server (4) through a second application protocol specific to the rights server (4), system characterized in that
said acquisition platform comprises:
means of defining an identifier I1 of the beneficiary with the commercial server (2) and an identifier I2 of said beneficiary with the rights server (4),
means of setting up a correspondence between the identifier I1 and the identifier I2 to of the beneficiary,
means of configuring at least one of said commercial server and said rights server to convert the identifier I1 into the identifier I2, and in that said commercial server (2) comprises:
means of generating an electronic ticket comprising one of said identifiers I1 or I2 of the beneficiary and the identifier of the content after receiving a right purchase request.
means of sending said ticket to the rights server (4); and in that said rights server comprises:
means of generating a purchased right depending on the content of the received ticket, and
means of sending the generated right to the beneficiary.

12. System according to claim 11, characterized in that it comprises a database (20) accessible by the commercial server (2) and/or the rights server (4) and comprising the correspondence between the identifier I1 and the identifier I2.

13. System according to claim 11, in which the rights server (4) is a Conditional Access System (CAS) provider.

14. System according to claim 11, in which the rights server (4) is a Digital Right Management (DRM) server.

15. System according to claim 11, in which the purchase module (6) for purchasing a right and the module (8) for using the purchased right are integrated into a terminal (24) of the beneficiary of the purchased right.

16. System according to claim 15, in which the terminal (24) of the beneficiary is a mobile telephone, a laptop computer or a personal digital assistant (PDA).

17. System according to claim 11, in which the purchase module (6) is integrated in a right purchasing terminal (24) and the usage module (8) is integrated in a terminal of the beneficiary of the purchased right.

18. System according to claim 17, in which the purchasing terminal (24) and the terminal of the beneficiary are either mobile telephones, laptop computers or personal digital assistants (PDAs).

19. Commercial transaction management server (2) in a contents distribution system also comprising a digital content usage rights server (4) and an operations platform (5) for said content, said platform (5) comprising a purchase module (6) of a right for a beneficiary capable of communicating with said commercial server (2) through a first application protocol specific to the commercial server (2) and a module (8) for using the purchased right capable of communicating with said rights server (4) through a second application protocol specific to the rights server (4), commercial server (2) characterized in that it comprises a communication module supporting a third application protocol enabling said commercial server (2) and the rights server (4) to exchange data related to the beneficiary, independently of said first and second application protocols.

20. Commercial server (2) according to claim 19, in which said third application protocol comprises means of setting up a correspondence between a beneficiary identifier with the commercial server (2) and an identifier of said beneficiary with the rights server (4).

21. Commercial server (2) according to claim 20, characterized in that it also comprises a database (20) in which said correspondence is recorded.

22. Digital content usage rights server (4) in a contents distribution system also comprising a commercial server (2) and an operations platform (5) of said content, said operations platform (5) comprising a right purchase module (2) for a beneficiary capable of communicating with said commercial server (2) through a first application protocol specific to the commercial server (2) and a module (8) for using the purchased right capable of communicating with said rights server (4) through a second application protocol specific to the rights server (4) characterized in that it comprises a communication module supporting a third application protocol enabling said commercial server (2) and said rights server (4) to exchange data related to the beneficiary independently of said first and second application protocols.

23. Rights server (4) according to claim 22, in which said third application protocol comprises means of setting up a correspondence between an identifier of the beneficiary with the commercial server (2) and an identifier of said beneficiary with the rights server (4).

24. Server according to claim 23, characterized in that it also comprises a database (20) in which said correspondence is recorded.
